(19) United States
(12) Patent Application Publication
(10) Pub. No.: US 2007/0130114 A1
(43) Pub. Date: Jun. 7, 2007

(54) METHODS AND APPARATUS TO OPTIMIZE PROCESSING THROUGHPUT OF DATA STRUCTURES IN PROGRAMS

(76) Inventors: Xiao-Feng Li, Beijing (CN); Lixia Liu, Beijing (CN); Dz-ching Ju, Saratoga, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/549,745

(22) Filed: Oct. 16, 2006

Related U.S. Application Data
(63) Continuation of application No. PCT/US05/21702, filed on Jun. 20, 2005.

(51) Int. Cl. G06F 17/30

(52) U.S. Cl. 707/2

(57) ABSTRACT

Methods and apparatus to optimize the processing throughput of data structures in programs are disclosed. A disclosed method to automatically optimize processing throughput of a data structure in a program comprises recording information representative of at least one access of the data structure, analyzing the representative information, and modifying the program to optimize the at least one access of the data structure based on the analysis, wherein modifying the program includes modifying at least one instruction of the program to translate one of the at least one access of the data structure from a first memory to a second memory.

### RELATED APPLICATIONS

This patent arises from a continuation of International Patent application No. PCT/US05/21702, entitled “Methods and Apparatus to Optimize Processing Throughput of Data Structures in Programs” which was filed on Jun. 05, 2005. International Patent application No. PCT/US05/21702 is hereby incorporated by reference in its entirety.

### FIELD OF THE DISCLOSURE

This disclosure relates generally to the throughput of data structures in programs, and, more particularly, to methods and apparatus to optimization the processing throughput of data structures in programs.

### BACKGROUND

In various applications a processor is programmed to process (e.g., read, modify and write) data structures (e.g., packets) flowing through the device in which the processor is embedded. For example, in network applications a network processor processes packets (e.g., reads and writes packet header, accesses packet layer-two header to determine packet type and necessary actions, accesses layer-three header to check and update time to live (TTL) and checksum fields, etc.) flowing through a router, a switch, or other network device. In a video server example, a video processor processes streaming video data (e.g., encoding, decoding, re-encoding, verifying, etc.). To achieve high performance (e.g., high packet processing throughput, large number of video channels, etc.), the program executing on the processor must be capable of processing the incoming data structures in a short period of time.

Many processors utilize a multiple level memory architecture, where each level may have a different capacity, access speed, and latency. For example, an Intel® IXP2400 network processor has external memory (e.g., dynamic random access memory (DRAM), etc.) and local memory (e.g., static random access memory (SRAM), scratch pad memory, registers, etc.). The capacity of DRAM is 1 Gigabyte with an access latency of 120 processor clock cycles, whereas the capacity of local memory is only 2560 bytes but with an access latency of 3 processor cycles.

Often, data structures to be processed have to be stored prior to processing. In applications requiring large quantities of data (e.g., network, video, etc.), usually the memory level with the largest capacity (e.g., DRAM) is used as a storage buffer. However, the long latency in accessing data structures stored in a slow memory level (e.g., DRAM) leads to inefficiency in the processing of data structures (i.e., low throughput). It has been recognized that, for high latency memory levels, the number of accesses to a data structure has a more direct impact on the processing throughput of data structures than the size (e.g., number of bytes) of the accesses. For example, for a Level 3 (L3) network switch application running on an Intel® IXP2400 network processor to support an Optical Carrier Level 48 (OC48) packet forwarding rate, the processor cannot have more than three 32 byte DRAM accesses in each thread (assuming one thread per Micro Engine (ME) running in a eight-thread context with a total of eight MEs).

It can be a significant challenge for application developers to carefully, explicitly, and manually (re-)arrange all data structure accesses in their application program code to meet such strict data structure access requirements.

### BRIEF DESCRIPTION OF THE DRAWINGS

FIG. 1A illustrates example program instructions containing data structure accesses.

FIG. 1B illustrates an optimized example version of the example code of FIG. 1A.

FIG. 2 is a schematic illustration of an example data structure throughput optimizer constructed in accordance with the teachings of the invention.

FIG. 3 is a schematic illustration of an example manner of implementing the data structure access tracer of FIG. 2.

FIG. 4 is a schematic illustration of an example data access graph.

FIG. 5 is a schematic illustration of the access entry for the table of FIG. 4.

FIG. 6 is a schematic illustration of an example manner of implementing the data structure access analyzer of FIG. 2.

FIG.7 is a schematic illustration of an example manner of implementing the data structure access optimizer of FIG. 2.

FIG. 8 is a flowchart representative of example machine readable instructions which may be executed to implement the data structure throughput optimizer of FIG. 2.

FIGS. 9A-C are flowcharts representative of example machine readable instructions which may be executed to implement the data structure access tracer of FIG. 2.

FIGS. 10A-B are flowcharts representative of example machine readable instructions which may be executed to implement the data structure access analyzer of FIG. 2.

FIGS. 11A-B are flowcharts representative of example machine readable instructions which may be executed to implement the data structure access optimizer of FIG. 2.

FIG. 12 is a schematic illustration of an example processor platform that may execute the example machine readable instructions represented by FIGS. 8, 9A-C, 10A-B, and/or 11A-B to implement data structure throughput optimizer, the data structure access tracer, the data structure access analyzer, and/or the data structure access optimizer of FIG. 2.

### DETAILED DESCRIPTION

To reduce data structure access time (i.e., increase processing throughput of data structures), due to slow memory (i.e., memory with high access latency), during execution of an example program, the program is modified to reduce the number of data structure accesses to the slow memory. In one example, this is accomplished by inserting one or more new program instructions to copy a data structure (or a portion of the data structure) from the slow memory to a fast (i.e., low latency) memory, and by modifying existing program instructions to access the copy of the data structure from the fast memory. Further, if the copy of the data structure in the fast memory is anticipated to be modified, added to, or changed by the program, one or more additional program instructions are inserted to copy the modified data structure from the fast memory back to the slow memory. The additional program instructions are inserted at processing end or split points (e.g., an end of a subtask, a call to another execution path, etc.).

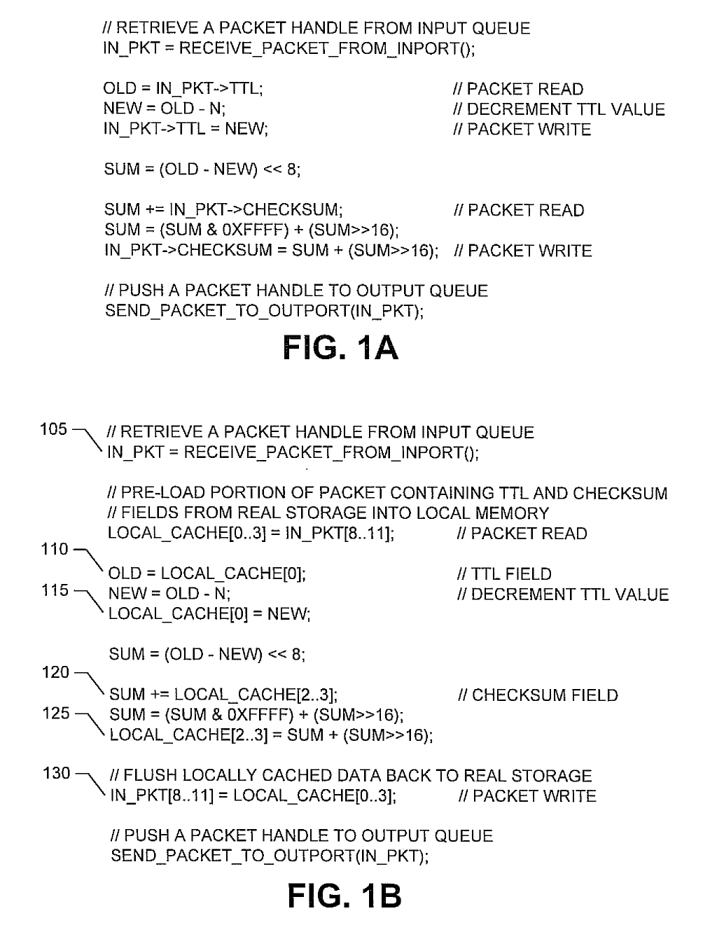

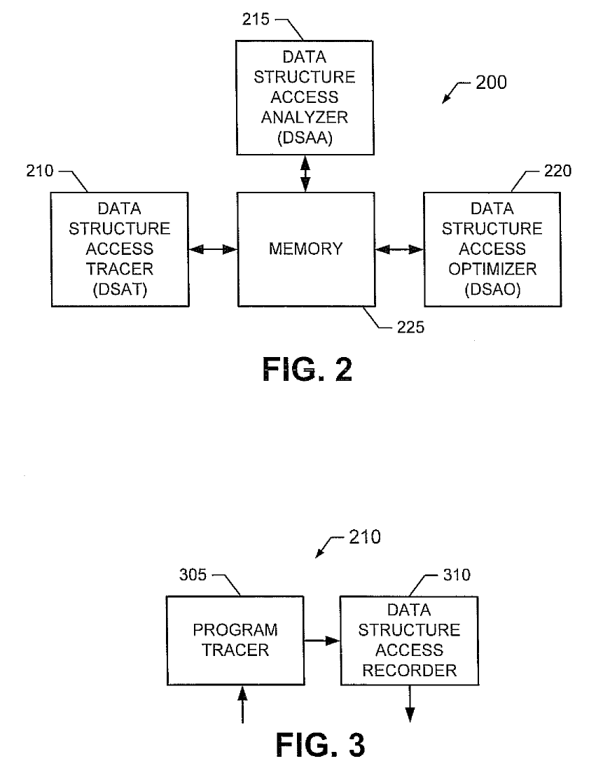

FIG. 1A contains example program instructions that read, modify, and write two fields (ttl (time to live) and checksum) of a data structure (i.e., the packet in_pkt). As shown by the annotations in the example code, the example program instructions of FIG. 1A require 2 data structure read accesses and 2 data structure write accesses from the slow memory.

FIG. 1B contains a version of the example instructions of FIG. 1A which have been optimized to require only a single data structure read access and a single data structure write access from the slow memory. In particular, instruction 105 of FIG. 1B pre-loads (i.e., copies) a portion of the packet from a storage (i.e., slow) memory into a local (i.e., fast) memory. Subsequent packet accesses (e.g., by instructions 110, 115, 120, and 125) are performed within the local memory. Once processing of the packet is completed, instruction 130 writes the packet from the local memory back to the storage memory (i.e., a packet write-back). By reducing the number of data structure accesses to the slow memory, the optimized example of FIG. 1B achieves improved processing throughput of the data structure.

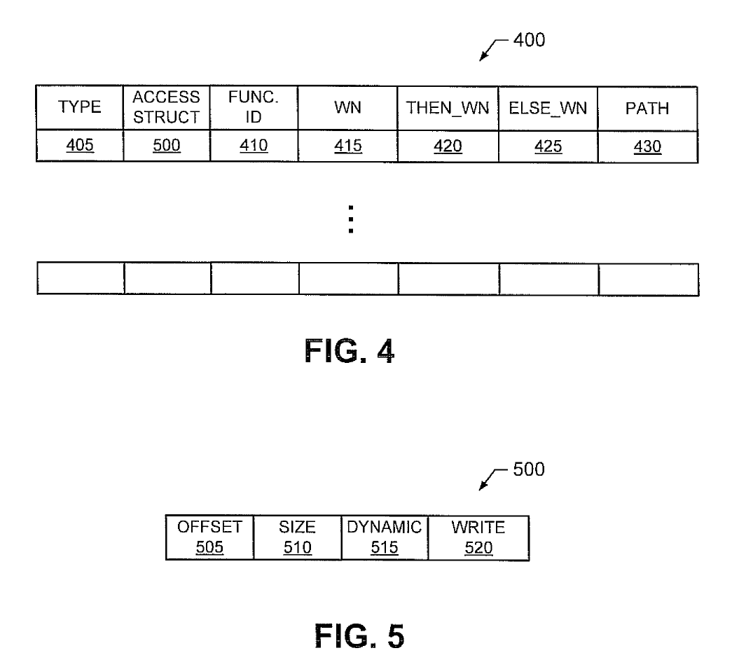

FIG. 2 is a schematic illustration of an example data structure throughput optimizer (DSTO) 200 constructed in accordance with the teachings of the invention. The example DSTO 200 of FIG. 2 includes a data structure access tracer (DSAT) 210, a data structure access analyzer (DSAA) 215, and a data structure access optimizer (DSAO) 220 to read, trace, analyze, and modify one or more portions of a program stored in a memory 225. In the example of FIG. 2, the DSTO 200 is implemented as part of a compiler that compiles the program. However, it should be readily apparent to persons of ordinary skill in the art that the DSTO 200 could be implemented separately from the compiler. For example, the DSTO 200 could optimize the processing throughput of data structures for the program (i.e., insert and/or modify program instructions) prior to or after compilation of the program.

It should be readily apparent to persons of ordinary skill in the art that portions of the program to be optimized can be selected using any of a variety of well known techniques. For example, the portions of the program may represent: (1) program instructions that are critical (e.g., as determined by a profiler, or known a priori to determine the processing throughput of data structures), (2) program instructions that are assigned to particular computational resources or units (e.g., to a ME of an Intel® IXP2400 network processor), and/or (3) program instructions that are considered to be cold (seldomly executed). Further, the portions of the program to be optimized may be determined using any of a variety of well known techniques (e.g., by the programmer, during compilation, etc.). Thus, in discussions throughout this document, “optimization of the program” is used, without restriction, to mean optimization of the entire program, optimization of multiple portions of the program, or optimization of a single portion of the program.

To identify and characterize anticipated data structure accesses in the program, the DSAT 210 of FIG. 2 reads the program, traces through each execution path (e.g., branches, conditional statements, calls, etc.) contained in the program, and records information representative of anticipated data accesses performed by the program. For example, the representative information includes read and write starting addresses, read and write access sizes, etc. for each anticipated data structure access (e.g., each read and/or write operation to slow memory). Thus, the representative information facilitates the characterization of anticipated data structure accesses in each execution path.

To characterize the anticipated data structure accesses in each execution path, the DSAA 215 of FIG. 2 traces through the representative information recorded by the DSAT 210, and generates aggregate data structure access information for each execution path. Example aggregate data structure access information includes a read starting address and size that encompasses all anticipated data structure read accesses performed within the execution path. Likewise, aggregate data structure access information may include a write starting address and size. Further, the DSAA 215 generates information necessary to translate each data structure access performed within the execution path such that the access is performed relative to an aggregate starting address (e.g., an offset). For example, a sequence of data structure accesses may have accessed (but not necessarily sequentially) the 15 ^{th} through the 23 ^{rd} byte of a data structure. Thus, an access to the 17 ^{th} byte would translate to an offset of 2 bytes using the 15 ^{th} byte as the starting address. It will be readily appreciated by persons of ordinary skill in the art that a pre-load or write-back of a portion of a data structure may access more data than actually read or written by the execution path. For example, this may occur when the parts accessed by two reads or writes are close, but not adjacent. However, as discussed above, the penalty for accessing extra data is often far less than the penalty for additional data structure accesses.

To optimize the data structure accesses, the DSAO 220 uses the aggregate data structure access information determined by the DSAA 215 to determine where and what program instructions to insert to pre-load all or a portion of a data structure, and to determine which and how to modify program instructions to operate on the pre-loaded all or portion of the data structure. If the program is expected to modify the pre-loaded data structure, the DSAO 220 inserts additional program instructions to write-back the modified portion of the data structure. The modified data structure may be written back to the original storage memory or another memory.

As will be readily appreciated by persons of ordinary skill in the art, the example DSTO 200 of FIG. 2 can be readily extended to handle (separately or in combination): dynamic data structure accesses, critical path data structure processing, or multiple processing elements. In an example, the DSAT 210 of FIG. 2 uses profiling information and/or network protocol information to estimate packet access information. The DSAA 215 of FIG. 2 estimates aggregate packet accesses (e.g., if a loop appends a packet header of size H to a packet in each iteration of a loop, and a profiled loop trip count is N, the estimated size of the aggregate packet access is H*N). Additionally, the DSAO 220 of FIG. 2 can insert additional program instructions to compare actual run-time data structure accesses with the copied portion of the data structure, and can insert further program instructions that access the data structure from the storage memory for accesses that exceed the copied portion of the data structure.

In a second example, the DSAT 210 of FIG. 2 only traces a critical path of the program, records anticipated data structure accesses in the critical path, and records split points (i.e., critical to non-critical path intersections) and join points (i.e., non-critical to critical path intersections). The DSAA 215 of FIG. 2 aggregates data structure access information in the critical path, and computes a data structure access summary at each split and join point (e.g., computes an aggregate write start and size from a start of a critical path to a split point). The DSAO 220 of FIG. 2 inserts program instructions, as discussed above. However, those additional program instructions are inserted at each split or join point (e.g., pre-load instructions at a join point, write-back instructions at a split point). If a program function is shared by a critical and a non-critical path, the example DSTO 200 can clone the function into each path so that optimizations are applied to the copy in the critical path, possibly leaving the copy in the non-critical path unchanged.

In a third example, the application is programmed for a multi-processor device that partitions the program into subtasks and assigns subtasks to different processing elements. For example, non-critical subtasks could be assigned to slower processing elements. The application may also be pipelined to exploit parallelism, with one stage on each processing element. Because a copy of a data structure in local (i.e., fast) memory cannot be shared across processing elements, pre-load and write-back program instructions are inserted at each processing entry (i.e., start of a subtask) and end (i.e., end of a subtask) point. In particular, the DSAT 210 of FIG. 2 traces and records anticipated data structure accesses in each subtask from processing entry to processing end points (including points where a data structure is sent to another subtask, e.g., a data send. The DSAA 215 of FIG. 2 determines aggregate data structure access information for each subtask, and the DSAO 220 of FIG. 2 inserts pre-load program instructions at each processing entry point, and write-back program instructions at each processing end point or each data send point (i.e., where a data structure is sent to another subtask).

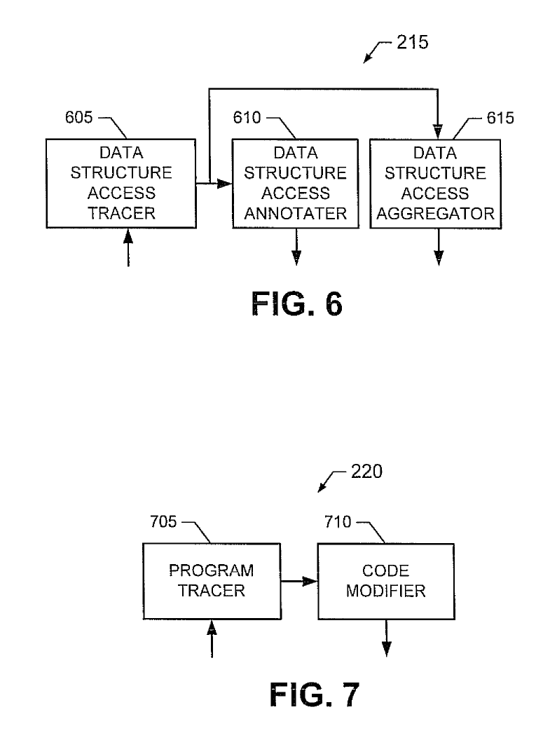

FIG. 3 illustrates an example manner of implementing the DSAT 210 of FIG. 2. To trace through each execution path (including branches, conditional statements, etc.) contained in the program and to record information representative of anticipated data accesses performed by the program instructions, the example of FIG. 3 includes a program tracer 305 and a data structure access recorder 310. In the example of FIG. 3, the program tracer 305 traces through the program (stored in the memory 225, see FIG. 2) by following an intermediate representation (IR) tree (also stored in the memory 225) generated from the program. The IR tree can be generated using any of a variety of well known techniques (e.g., using a compiler). Further, the program tracer 305 assumes that each execution path has a corresponding entry function.

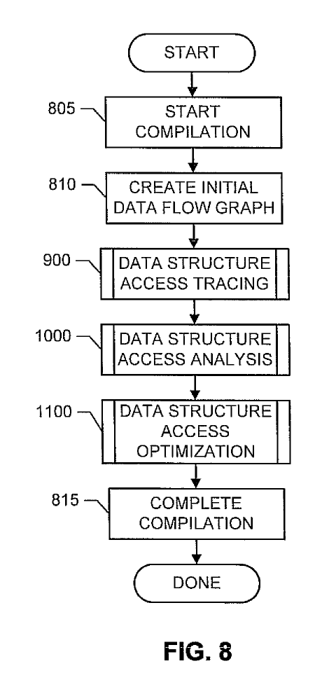

The data structure access recorder 310 records and stores in the memory 225 information representative of the flow of anticipated data structure accesses for each execution path from the entry function to each execution path end point or data send point (i.e., a point where a data structure is sent to another subtask or execution path). FIG. 4 illustrates an example table 400 for storing the representative information. The example table 400 of FIG. 4 contains one entry (i.e., one row of the table 400) for each anticipated data structure access. By recording sequential entries in the table 400, the data structure access recorder 310 creates a data access graph (i.e., tree) representative of the flow of anticipated data structure accesses for the program. The structure of the data access graph will, in general, mirror the structure of the IR tree. In the illustrated example of FIG. 4, each entry in the table 400 corresponds to a node in the IR tree. However, since not all nodes in the IR tree correspond to a data structure access node or program flow node (e.g., call, if, etc.), some nodes in the IR tree may not have entries in the table 400 (i.e., data access graph).

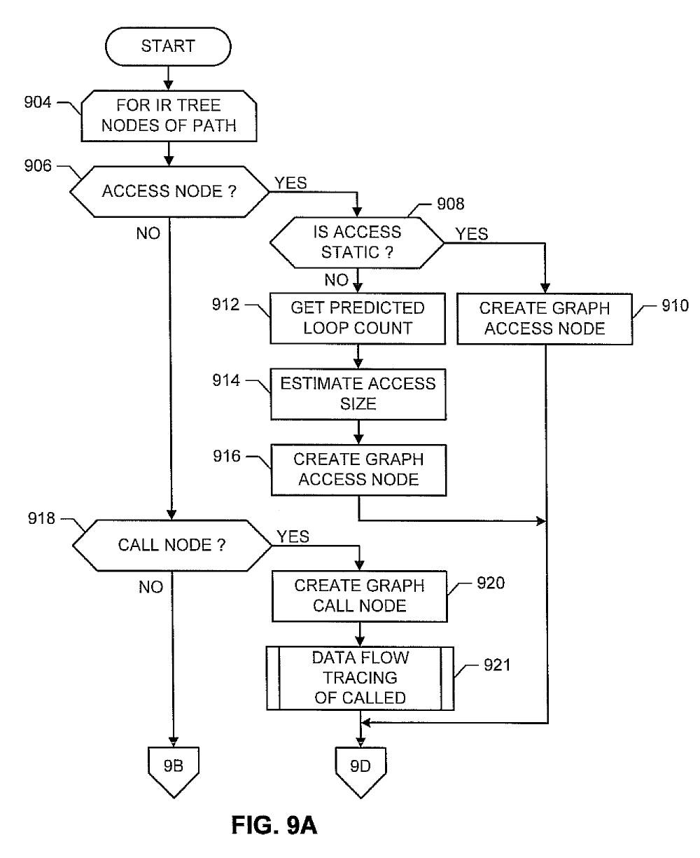

Each entry in the table 400 of FIG. 4 contains a type 405 (e.g., data structure access, data send, call, if, end, etc.), an access entry 500 (discussed below in connection with FIG. 5), a function symbol index 410 (for call nodes and data structure write), a wn field 415 (that identifies the corresponding node of the IR tree), a then_wn field 420 (that identifies the corresponding “then” node for an “if” node of the IR tree), an else_wn field 425 (that identifies the corresponding “else” node for an “if” node of the IR tree), and path 430 (an identifier for the current execution path).

FIG. 5 illustrates an example access entry 500 that contains an offset 505 (i.e., the starting point for the data structure access relative to the beginning of the data structure), a size 510 (e.g., the number of bytes accessed), a dynamic flag 515 (indicating if the access offset and size are static or dynamic), and a write flag 520 (indicating if the access is read or write). It will be readily apparent to persons of ordinary skill in the art, that other methods of recording the representative information illustrated in FIGS. 4 and 5 could be used. For example, using data structures, linked lists, etc. Further, if the DSAT 210 and the DSAA 215 of FIG. 2 are implemented together, the recorded representative information could only be temporarily retained rather than stored in a table, data structure, linked list, etc.

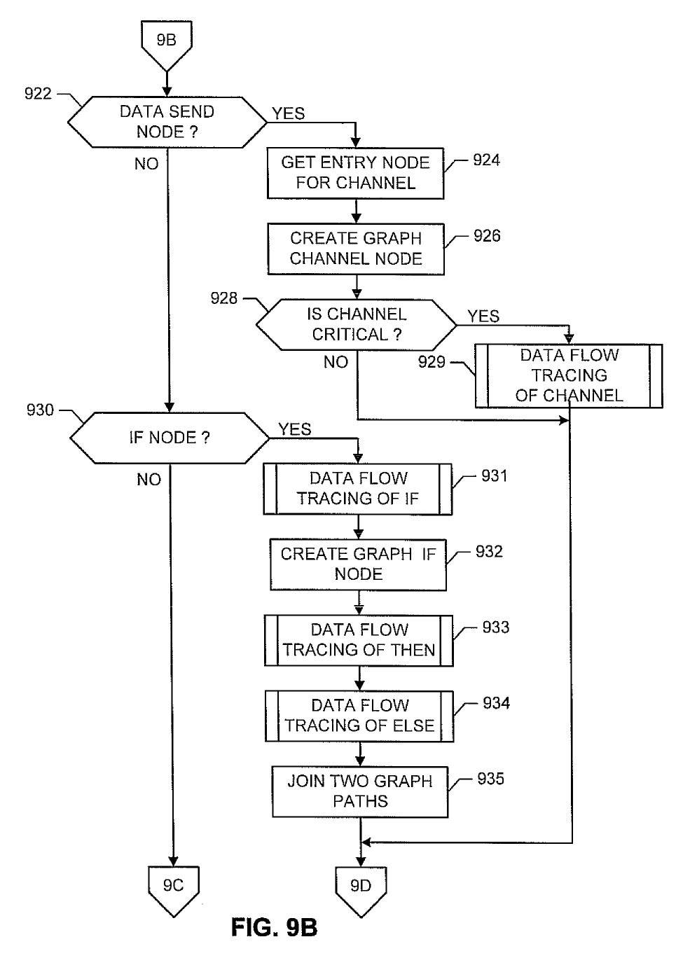

FIG. 6 illustrates an example manner of implementing the DSAA 215 of FIG. 2. To trace through the data access graph (i.e., the table 400) determined by the DSAT 210 of FIG. 2, the example of FIG. 6 includes a data structure access tracer 605. To determine information required by the DSAO 220 of FIG. 2 to perform program instruction modifications and insertions, the example of FIG. 6, also includes a data structure access annotator 610 and a data structure access aggregator 615.

As the data structure access tracer 605 traces through the data access graph, the data structure access tracer 605 provides information to the data structure access annotator 610 and the data structure access aggregator 615. For example, at a data structure read node, the data structure access tracer 605 instructs the data structure access annotator 610 to annotate the corresponding node in the IR tree. The annotations contain information required by the DSAO 220 to perform program instruction modifications (e.g., to translate a data structure read from the storage memory to the local memory, and to translate the read relative to the beginning of the portion of the data structure that is pre-loaded rather than from the beginning of the data structure). In another example, at a call to another subtask the data structure access tracer 605 instructs the data structure access annotator 610 to insert and annotate a new node in the IR tree corresponding to a data structure write-back. It should be readily apparent to persons of ordinary skill in the art that other methods of determining and/or marking program instructions for modification or insertion could be used. For example, the data structure access annotator 610 can insert temporary “marking” codes into the program containing information indicative of changes to be made. The DSAO 220 could then locate the “marking” codes and make corresponding program instruction modifications or insertions.

At each data structure access (read or write) node, the data structure access tracer 605 passes information on the access to the data structure access aggregator 615. The data structure access aggregator 615 accumulates data structure access information for the execution path. For example, the data structure access aggregator 615 determines the required offset and size of a data structure pre-load, and the required offset and size of a data structure write-back. The information accumulated by the data structure access aggregator 615 is used by the DSAO 220 to generate inserted program instructions to realize data structure pre-loads and write-backs.

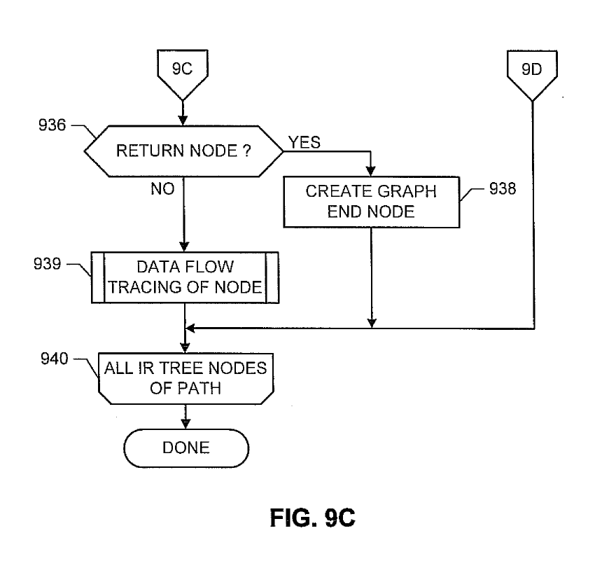

FIG. 7 illustrates an example manner of implementing the DSAO 220 of FIG. 2. To re-trace the program (e.g., using the annotated IR tree) and to modify and insert program instructions, the example of FIG. 7 includes a program tracer 705 and a code modifier 710. In the example of FIG. 7, the program tracer 705 traces through the program (stored in the memory 225) by following the annotated IR tree (stored in the memory 225) created by the DSAA 215. At each node of the annotated IR tree containing annotations, the program tracer 705 instructs the code modifier 710 to perform the corresponding program instruction modifications or insertions. For example, at an inserted data structure pre-load node, the program tracer 705 provides to the code modifier 710 the parameters of a data structure pre-load (e.g., data structure identifier, offset, size, etc.) that the code modifier 710 inserts into the program instructions. In another example, at a data structure access node, the program tracer 705 provides to the code modifier 710 translation parameters representative of the program instruction modifications to be performed by the code modifier 710 (e.g., location of the pre-loaded data structure, offset, etc.).

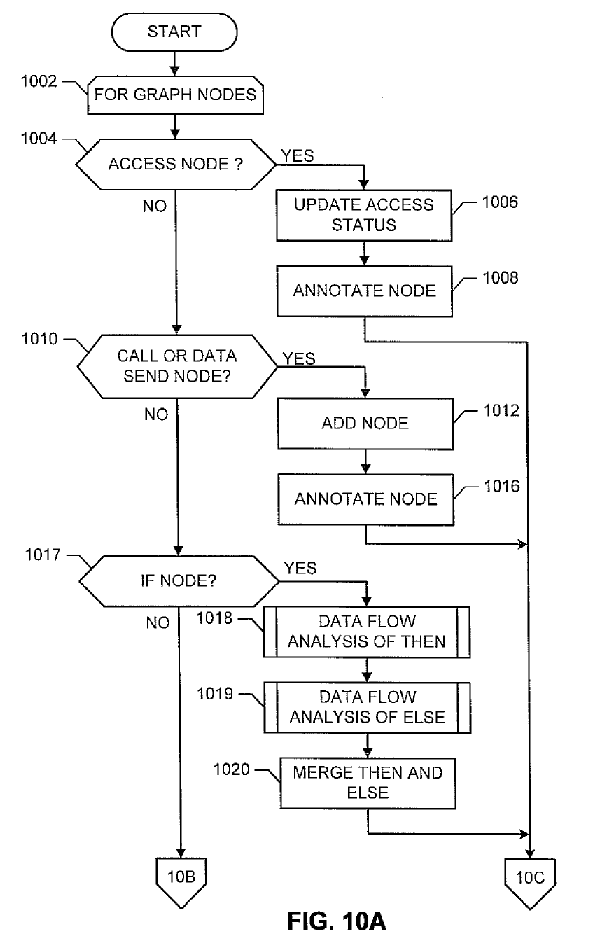

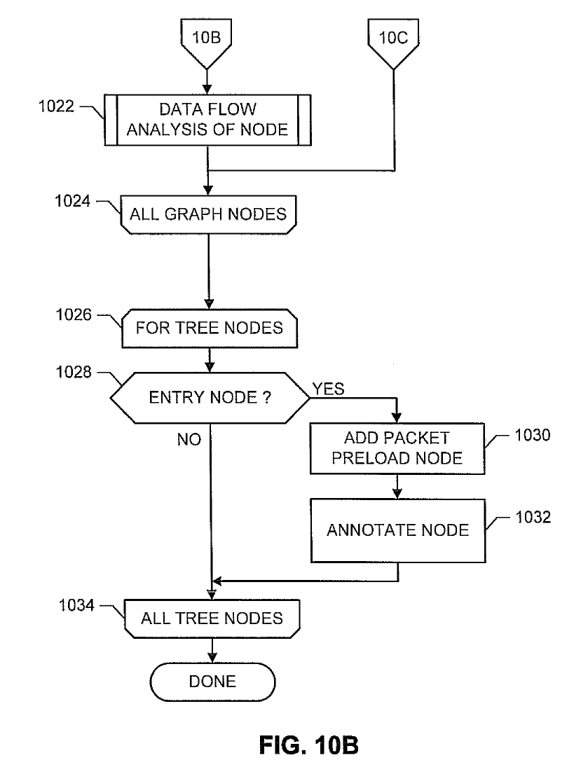

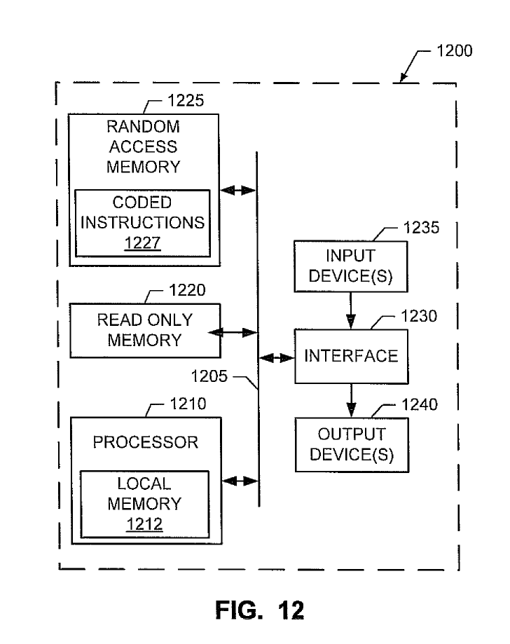

FIGS. 8, 9A-C, 10A-B, and 11A-B illustrate flowcharts representative of example machine readable instructions that may be executed by an example processor 1210 of FIG. 12 to implement the example DSTO 200, the example DSAT 210, the example DSAA 215, and the DSAO 220, respectively. The machine readable instructions of FIGS. 8, 9A-C, 10A-B, and 11A-B may be executed by a processor, a controller, or any other suitable processing device. For example, the machine readable instructions of FIGS. 8, 9A-C, 10A-B, and 11A-B may be embodied in coded instructions stored on a tangible medium such as a flash memory, or random-access memory (RAM) associated with the processor 1210 shown in the example processor platform 1200 discussed below in conjunction with FIG. 12. Alternatively, some or all of the machine readable instructions of FIGS. 8, 9A-C, 10A-B, and 11A-B may be implemented using an application specific integrated circuit (ASIC), a programmable logic device (PLD), a field programmable logic device (FPLD), discrete logic, etc. Also, some or all of the machine readable instructions of FIGS. 8, 9A-C, 10A-B, and 11A-B may be implemented manually or as combinations of any of the foregoing techniques. Further, although the example machine readable instructions of FIGS. 8, 9A-C, 10A-B, and 11A-B are described with reference to the flowchart of FIGS. 8, 9A-C, 10A-B, and 11A-B, persons of ordinary skill in the art will readily appreciate that many other methods of implementing the example DSTO 200, the example DSAT 210, the example DSAA 215, and the DSAO 220 exist. For example, the order of execution of the blocks may be changed, and/or some of the blocks described may be changed, eliminated, or combined.

The example machine readable instructions of FIGS. 8, 9A-C, 10A-B, and 11A-B may be implemented using any of a variety of well-known techniques. For example, using object oriented program techniques, and using structures for storing program variables, the IR tree, and the data access graph. In particular, the access entry 500 could be implemented using a “struct”, and the data access graph (i.e., the table 400) and data structure access recorder 315 could be implemented using an object oriented “class” containing public functions to add nodes to the graph (e.g., inserting a data structure access node, inserting a data structure write node, inserting a program call node, inserting an end node, inserting an if node, etc.).

It should be readily apparent to persons of ordinary skill in the art, that the example machine readable instructions of FIGS. 8, 9A-C, 10A-B, and 11A-B can be applied to programs in a variety of ways. In the earlier example of the OC48 L3 switch application executing on an Intel® IXP2400 network processor, there are a variety of choices in how to optimize the program. In a preferred example, only critical execution paths assigned to MEs are optimized, and packet pre-loads and write-backs are inserted at the entry, exit, call, and data send points of each critical execution path. In another example, optimization is performed globally, is applied to all execution paths, packet pre-loads are included at the entry point of a receive module (that receives packets from a network card), and packet write-backs are included at the end point of a transmit module (that provides packets to a network card). In a further example, optimization is performed on a processing element (e.g., ME) basis, and packet pre-loads and write-backs are inserted at the entry and exit points for a processing unit.

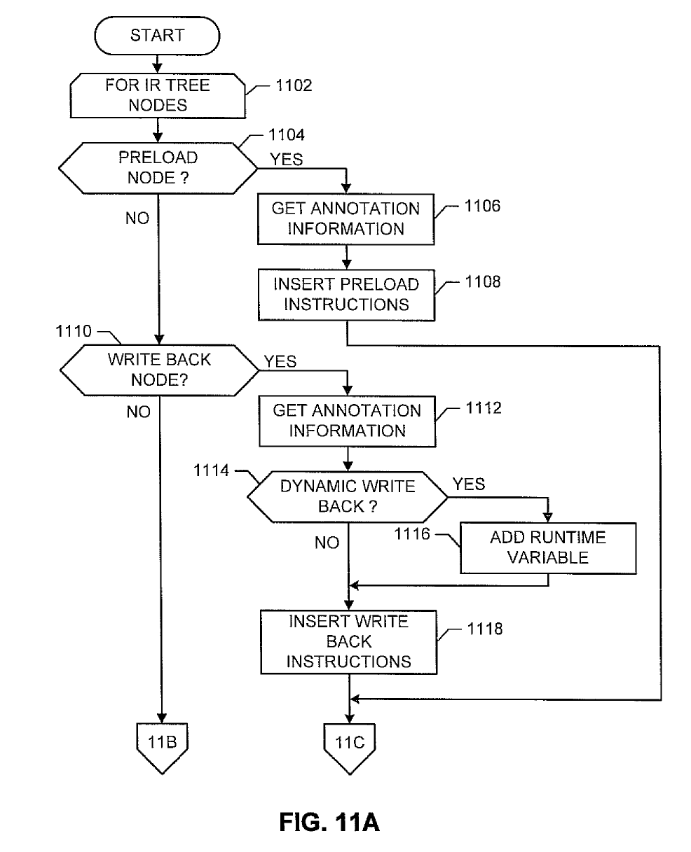

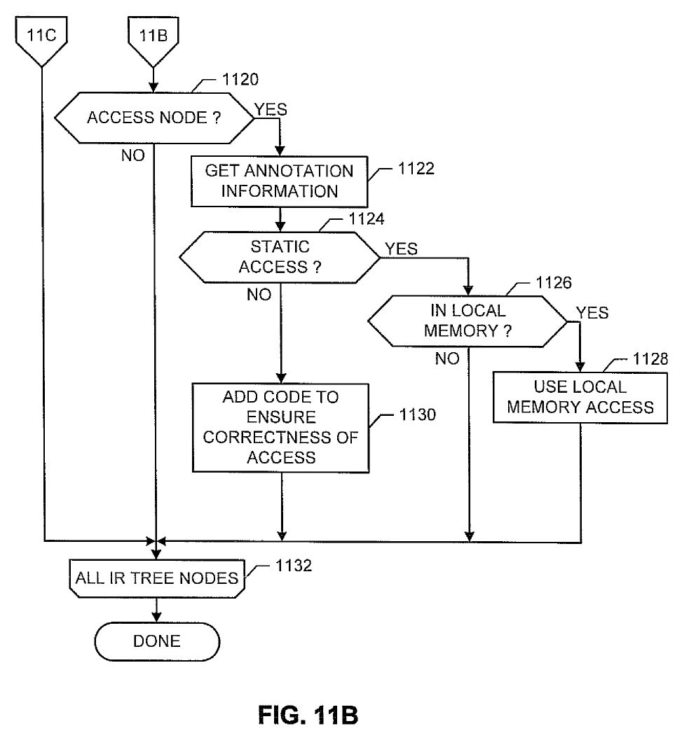

The example machine readable instructions of FIG. 8 begin when the DSTO 200 starts compilation of the program (block 805). The compilation proceeds far enough to generate the IR tree for the program and to profile the program (e.g., determine loop counts, etc. for dynamic access portions of the program). The DSAT 210 creates an initial (i.e., empty or null) data flow graph (block 810), and traces the anticipated data structure accesses to create the data access graph (block 900) using, for instance, the example machine readable instructions of FIGS. 9A-C. The DSAA 215 analyses the data access graph and annotates the IR tree (block 1000) using, for instance, the example machine readable instructions of FIGS. 10A-B. The DSAO 220 modifies the program to optimize the processing throughput of data structures (block 1100) based on the annotated IR tree using, for instance, the example machine readable instructions of FIGS. 11A-B. Finally, the DSTO 200 ends the example machine readable instructions of FIG. 8 after completing the remaining portions of the compilation process for the optimized program (block 815).

The example machine readable instructions of FIGS. 9A-C trace the anticipated data structure accesses to create the data access graph. As illustrated in FIGS. 9A-C, the example machine readable instructions of FIGS. 9A-C are performed recursively. The example machine readable instructions of FIGS. 9A-C process each node of the portion of the IR tree for an execution path (typically signified by an entry node in the IR tree) (node 904). The DSAT 210 determines if the node is a data structure access node (block 906). If the node is a data structure access node, the DSAT 210 determines if the access is static (block 908). If the data structure access is static, the DSAT 210 creates a data structure access node in the data flow graph (block 910). Control then proceeds to block 940 of FIG. 9C. If the data structure access is dynamic (block 908), the DSAT 210 gets the predicted loop count from the program profile information (block 912), estimates the data structure access size (block 914), and creates a data structure access node in the data flow graph (block 916). Control then proceeds to block 940 (FIG. 9C).

Returning, for purposes of discussion to block 906, the node is not a data structure access node, the DSAT 210 determines if the node is a call node (block 918). If the node is a call node, the DSAT 210 creates a call node in the data flow graph (block 920) and traces the data structure accesses of the called program (block 921) by recursively using the example machine readable instructions of FIGS. 9A-C. After the recursive execution returns (block 921), control proceeds to block 940 (FIG. 9C).

Returning, for purposes of discussion to block 918, the node is not a call node, the DSAT 210 determines if the node is a data send (i.e., a transfer of a data structure to another execution path) node (FIG. 9B, block 922). If the node is a data send node (block 922), the DSAT 210 determines the entry point for the other execution path (block 924) and creates a data send node in the data flow graph (block 926). The DSAT 210 then determines if the other execution path is critical (block 928). If the other execution path is critical, the DSAT 210 traces the data structure accesses of the other execution path (block 929) by recursively using the example machine readable instructions of FIGS. 9A-C. After the recursive execution returns (block 929), control proceeds to block 940 (FIG. 9C).

Returning, for purposes of discussion to block 922, the node is not a data send node, the DSAT 210 determines if the node is an if (i.e., conditional) node (block 930). If the node is an if node (block 930), the DSAT 210 traces the data structure accesses of the if path (block 931) by recursively using the example machine readable instructions of FIGS. 9A-C. After the recursive execution returns (block 931), the DSAT 210 then creates an if node in the data flow graph (block 932), and traces the data structure accesses of the then path (block 933) by recursively using the example machine readable instructions of FIGS. 9A-C. After the recursive execution returns (block 933), the DSAT 210 next traces the data structure accesses of the else path (block 934) by recursively using the example machine readable instructions of FIGS. 9A-C. After the recursive execution returns (block 934), the DSAT 210 then joins the two paths in the data flow graph (block 935) and control proceeds to block 940 of FIG. 9C.

Returning, for purposes of discussion to block 930, the node is not an if node, the DSAT 210 determines if the node is a return, end of execution path, or data structure drop (e.g., abort, ignore modifications, etc.) node (block 936 of FIG. 9C). If the node is a return, end of execution path, or data structure drop node, the DSAT 210 creates an exit node in the data flow graph (block 938). Control then proceeds to block 940. If the node is not a return, end of execution path, or data structure drop node (block 936), the DSAT 210 traces the data structure accesses of the node (block 939) by recursively using the example machine readable instructions of FIGS. 9A-C. After the recursive execution returns (block 939), if all nodes of the execution path have been processed (block 940), the DSAT 210 ends the example machine readable instructions of FIGS. 9A-C. Otherwise, control returns to block 904 of FIG. 9A.

The example machine readable instructions of FIGS. 10A-B analyze the data access graph and annotate the IR tree. As illustrated in FIGS. 10A-B, the example machine readable instructions of FIGS. 10A-B are performed recursively. The example machine readable instructions of FIGS. 10A-B process each node of a portion of the data flow graph for an execution path (block 1002). The DSAA 215 determines if the node is a data structure access node (block 1004). If the node is an access node (block 1004), then the DSAA 215 updates the information representative of the aggregate accesses of the data structure (block 1006), and annotates the corresponding IR node (block 1008). Control then proceeds to block 1024 of FIG. 10B.

Returning, for purposes of discussion to block 1004, the node is not a data structure access node, the DSAA 215 determines if the node is a call or data send node (block 1010). If the node is a call or data send node (block 1010), the DSAA 215 adds a write-back node to the IR tree (block 1012) and the DSAA 215 annotates the new write-back node (block 1016). Control then proceeds to block 1024 of FIG. 10B.

Returning, for purposes of discussion to block 1010, the node is not a call or data send node, the DSAA 215 determines if the node is an if node (block 1017). If the node is an if node (block 1017), the DSAA 215 recursively analyzes the portion of the data access graph for the then path and annotates the IR tree using the example machine readable instructions of FIGS. 10A-B (block 1018). After the recursive execution returns (block 1018), the DSAA 215 then recursively analyzes the portion of the data access graph for the else path and annotates the IR tree using the example machine readable instructions of FIGS. 10A-B (block 1019). After the recursive execution returns (block 1019), the DSAA 215 then merges (i.e., combines) the information representative of the aggregate accesses of the data structure for the then and else paths (block 1020). Control then proceeds to block 1024 of FIG. 10B.

Returning, for purposes of discussion to block 1017, the node is not an if node, the DSAA 215 recursively analyzes the portion of the data access graph for the other path (i.e., the portion of the data access graph starting with the node) and annotates the IR tree using the example machine readable instructions of FIGS. 10A-B (block 1022). After the recursive execution returns (block 1022), control proceeds to block 1024.

After all data flow graph nodes for the execution path have been processed (block 1024), the DSAA 215 processes all nodes in the IR tree (block 1026). The DSAA 215 determines if the node is an execution path entry node (block 1028). If the node is an entry node (block 1028), the DSAA 215 adds a data structure pre-load node to the IR tree (block 1030) and annotates the added pre-load node with the information representative of the aggregate read data structure data accesses (block 1032) and control proceeds to block 1034. At block 1034, the DSAA 215 determines if all IR tree nodes have been processed. If so, the DSAA 215 ends the example machine readable instructions of FIGS. 10A-B. Otherwise, control returns to block 1002 of FIG. 10A.

It will be readily apparent to persons of ordinary skill in the art that the example machine readable instructions of FIGS. 9A-C and 10A-B could be combined and/or executed simultaneously. For example, the DSTO 200 could annotate the IR tree while tracing the anticipated data structure accesses in the program. In particular, the recorded representative information could be retained only long enough to be analyzed and corresponding IR tree annotations created. In this fashion, the recorded representative information is not necessarily stored (i.e., retained) in a table, data structure, etc.

The example machine readable instructions of FIGS. 11A-B modify the program based on the annotated IR tree to optimize the processing throughput of data structures. The example machine readable instructions of FIGS. 11A-B process each node of the annotated IR tree (block 1102). The DSAO 220 determines if the node is a data structure pre-load node (block 1104). If the node is a data structure pre-load node (block 1104), the DSAO 220 reads the annotation information from the pre-load node (block 1106) and inserts into the program pre-load program instructions corresponding to the annotation information (block 1108). Control proceeds to block 1132 of FIG. 11B.

Returning, for purposes of discussion to block 1104, the node is not a pre-load node, the DSAO 220 determines if the node is a data structure write-back node (block 1110). If the node is a write-back node (block 1110), the DSAO 220 reads the annotation information for the node (block 1112) and determines if modifications to the data structure are dynamic or static (block 1114). If modifications are dynamic (block 1114), the DSAO 220 inserts program instructions to create a run-time variable that tracks what portion(s) of the data structure has been modified (block 1116), and then control proceeds to block 1118. Returning, for purposes of discussion to block 1114, the modifications are not dynamic, the DSAO 220 inserts program instructions to perform the data-structure write-back (block 1118), and control then proceeds to block 1132 of FIG. 11B.

Returning, for purposes of discussion to block 1110, the node is not a write-back node, the DSAO 220 determines if the node is a data structure access node (block 1120 of FIG. 11B). If the node is an access node (block 1120), the DSAO 220 reads the annotation information for the node (block 1122). The DSAO 220 next determines if the access is static or dynamic (block 1124). If the access is static (block 1124), the DSAO 220 determines if the accessed portion of the data structure is in local memory (block 1126). If the accessed portion is in local memory (block 1126), the DSAO 220 then modifies (based on the annotation information) the program instructions to access the data structure from local memory (block 1128), and control proceeds to block 1132. If the accessed portion is not in local memory (block 1126), the DSAO 220 leaves the current data structure access instructions unchanged (i.e., makes no code modifications), and control proceeds to block 1132.

Returning, for purposes of discussion to block 1124, the access is dynamic, the DSAO 220 inserts and modifies the program code to verify that accesses of the data structure access the correct memory level (e.g., access the local memory for the pre-loaded portion), and to access the data structure from the correct memory level (block 1130). Control then proceeds to block 1132.

Returning, for purposes of discussion to block 1124, the node is not an access node, control proceeds to block 1132. The DSAO 220 determines if all nodes have been processed (block 1132). If all nodes of the IR tree have been processed (block 1132), the DSAO 220 ends the example machine readable instructions of FIGS. 11A-B. Otherwise, control returns to block 1102 of FIG. 11A.

FIG. 12 is a schematic diagram of an example processor platform 1200 capable of implementing the example machine readable instructions illustrated in FIGS. 8, 9A-C, 10A-B, and 11A-B. For example, the processor platform 1200 can be implemented by one or more general purpose microprocessors, microcontrollers, etc.

The processor platform 1200 of the example includes the processor 1210 that is a general purpose programmable processor. The processor 1210 executes coded instructions present in a memory 1227 of the processor 1210. The processor 1210 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. The processor 1210 includes a local memory 1212. The processor 1210 may execute, among other things, the example machine readable instructions illustrated in FIGS. 8, 9A-C, 10A-B, and 11A-B.

The processor 1210 is in communication with the main memory including a read only memory (ROM) 1220 and/or a RAM 1225 via a bus 1205. The RAM 1225 may be implemented by Synchronous Dynamic Random Access Memory (SDRAM), Dynamic DRAM, and/or any other type of RAM device. The ROM 1220 may be implemented by flash memory and/or any other desired type of memory device. Access to the memory space 1220, 1225 is typically controlled by a memory controller (not shown) in a conventional manner. The RAM 1225 may be used by the processor 1210 to implement the memory 225, and/or to store coded instructions 1227 that can be executed to implement the example machine readable instructions illustrated in FIGS. 8, 9A-C, 10A-B, and 11A-B

The processor platform 1200 also includes a conventional interface circuit 1230. The interface circuit 1230 may be implemented by any type of well known interface standard, such as an external memory interface, serial port, general purpose input/output, etc. One or more input devices 1235 are connected to the interface circuit 1230. One or more output devices 1240 are also connected to the interface circuit 1230.

Of course, one of ordinary skill in the art will recognize that the order, size, and proportions of the memory illustrated in the example systems may vary. For example, the user/hardware variable space may be larger than the main firmware instructions space. Additionally, although this patent discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above described example systems, persons of ordinary skill in the art will readily appreciate that the examples are not the only way to implement such systems.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to automatically optimize processing throughput of a data structure in a program comprising:
recording information representative of at least one access of the data structure;
analyzing the recorded representative information; and
modifying the program to change the at least one access of the data structure based on the analysis, wherein modifying the program includes modifying at least one instruction of the program to translate one of the at least one access of the data structure from a first memory to a second memory.

2. A method as defined in claim 1, wherein the representative information includes estimated dynamic data structure accesses.

3. A method as defined in claim 1, wherein the first memory is external and the second memory is local.

4. A method as defined in claim 1, wherein recording of the representative information includes recording information representative of accesses occurring in at least one of: (a) all branches of the program, (b) a critical path of the program, or (c) a subtask of the program assigned to one of a plurality of processing elements.

5. A method as defined in claim 1, wherein analyzing the recorded representative information comprises:
determining parameters associated with multiple accesses of the data structure; and
defining a new data structure access based on the determined parameters.

6. A method as defined in claim 5, wherein modifying the program includes inserting code into the program to perform the new data structure access.

7. A method as defined in claim 1, wherein modifying the program comprises:
inserting first code into the program to copy a first portion of the data structure from a first memory into a second memory; and
modifying at least one instruction of the program to access the data structure from the second memory.

8. A method as defined in claim 7, further comprising inserting second code into the program to copy a second portion of the data structure from the second memory to either the first or a third memory.

9. A method as defined in claim 8, wherein the second portion of the data structure includes at least a third portion of the data structure modified by the program.

10. A method as defined in claim 8, wherein the second portion of the data structure is determined dynamically during program execution.

11. A method as defined in claim 7, wherein the first portion of the data structure includes at least a third portion of the data structure read by the program.

12. A method as defined in claim 7, wherein modifying the program further comprises inserting second code into the program to dynamically compute parameters representative of portions of the data structure accessed.

13. A method as defined in claim 12, wherein modifying the program further comprises inserting third code into the program that changes a data structure access based upon the dynamically computed parameters.

14. An apparatus to optimize processing throughput of a data structure in a program comprising:
a data structure access tracer to record information representative of at least one access of the data structure;
a data structure access analyzer to analyze the representative information recorded by the data structure access tracer; and
a code modifier to modify at least one instruction of the program to change the at least one access of the data structure based on the analysis.

15. An apparatus as defined in claim 14, wherein the data structure access tracer records information representative of estimated dynamic data structure accesses.

16. An apparatus as defined in claim 14, wherein the code modifier modifies at least one instruction of the program to translate a data structure access from a first memory to a second memory.

17. An apparatus as defined in claim 14, wherein
the data structure access analyzer determines parameters associated with multiple accesses of the data structure; and
the code modifier inserts code into the program to perform a new data structure access based on the determined parameters.

18. An apparatus as defined in claim 14, wherein the code modifier:
inserts first code into the program to copy a portion of the data structure from a first memory into a second memory; and
modifies at least one instruction of the program to access the data structure from the second memory.

19. An apparatus as defined in claim 18, wherein the code modifier inserts second code into the program to copy a second portion of the data structure from the second memory to either the first or a third memory.

20. An apparatus as defined in claim 19, wherein the second portion of the data structure is determined dynamically during program execution.

21. An apparatus as defined in claim 18, wherein the code modifier:
inserts second code into the program to dynamically compute parameters representative of portions of the data structure accessed; and
inserts third code into the program that changes a data structure access based upon the dynamically computed parameters.

22. An article of manufacture storing machine readable instructions which, when executed, cause a machine to:
record information representative of at least one access of a data structure in a program;
analyze the recorded representative information; and
modify the program to change the at least one access of the data structure based on the analysis, wherein modifying the program includes modifying at least one instruction of the program to translate one of the at least one access of the data structure from a first memory to a second memory.

23. An article of manufacture as defined in claim 22, wherein the machine readable instructions, when executed, cause the machine to record information representative of estimated dynamic data structure accesses.

24. An article of manufacture as defined in claim 22, wherein the machine readable instructions, when executed, cause the machine to:
determine parameters associated with multiple accesses of the data structure; and
insert code into the program to perform a new data structure access based on the determined parameters.

25. An article of manufacture as defined in claim 22, wherein the machine readable instructions, when executed, cause the machine to:
insert first code into the program to copy a portion of the data structure from a first memory into a second memory; and
modify at least one instruction of the program to change one of the at least one access of the data structure to access the data structure from the second memory.

26. An article of manufacture as defined in claim 25, wherein the machine readable instructions, when executed, cause the machine to insert second code to copy a second portion of the data structure from the second memory to either the first or a third memory.

27. An article of manufacture as defined in claim 26, wherein the machine readable instructions, when executed, cause the machine to insert third code into the program to determine the second portion of the data structure dynamically during program execution.

28. An article of manufacture as defined in claim 25, wherein the machine readable instructions, when executed, cause the machine to:
insert second code into the program to dynamically compute parameters representative of portions of the data structure accessed; and
insert third code into the program that changes a data structure access based upon the dynamically computed parameters.

29. A system to optimize processing throughput of a data structure in a program comprising:
a data structure access tracer to record information representative of at least one access of the data structure;
a data structure access analyzer to analyze the representative information recorded by the data structure access tracer;
a code modifier to modify at least one instruction of the program to change the at least one access of the data structure based on the analysis; and
a dynamic random access memory.

30. A system as defined in claim 29, wherein the code modifier modifies at least one instruction of the program to translate a data structure access from a first memory to a second memory.
